(19) United States
(12) Patent Application Publication
(10) Pub. No.: US 2015/0307016 A1
(43) Pub. Date: Oct. 29, 2015

(54) Folding Divider Device

(71) Applicant: Alton Payne, Chapin, SC (US)

(72) Inventor: Alton Payne, Chapin, SC (US)

(21) Appl. No.: 14/645,827

(22) Filed: Mar. 12, 2015

Related U.S. Application Data
(60) Provisional application No. 61/983,627, filed on Apr. 24, 2014.

(51) Int. Cl. B60P 7/14

(52) U.S. Cl. CPC B60P 7/14

(57) ABSTRACT

A folding divider device for separating and transporting items on a truck bed. The divider device includes a first and second panel pivotally connected by a spring-biased hinge that allows the device to open and fold for installation and uninstallation. The surface of the panels comprise one or more channels, wherein one or more dividers are removably attached thereto. The dividers are positioned perpendicularly to the panels to create compartments therebetween. The device further includes inserts that can be used to adjust the length of the device so it fits within a user's truck bed. To prevent the device from shifting while in use, the inserts can removably attach to end pieces, wherein the end pieces can attach to the sides of a truck bed. In the alternative, the inserts can removably attach directly to grooves on the sides of a truck bed.

### CROSS REFERENCE TO RELATED APPLICATION

This application claims the benefit of U.S. Provisional Application No. 61/983,627 filed on Apr. 24, 2014. The above identified patent application is herein incorporated by reference in its entirety to provide continuity of disclosure.

### BACKGROUND OF THE INVENTION

### Field of the Invention

The present invention relates to folding divider devices. More specifically, the present invention provides a folding divider device that allows a user to separate and transport items in a truck bed. The device includes a first and second panel pivotally connected by a spring-biased hinge. The panels comprise one or more pairs of vertical supports thereon that form a channel therebetween, wherein one or more dividers can be removably attached to the channels. The device further includes a first and second end piece adapted to attach to the sides of a truck bed. A first and second insert connects an end piece to a panel, wherein the insert is used to adjust the length of the device to fit within a truck bed. In an alternative embodiment, the inserts can removably attach directly to grooves on the sides of a truck bed.

Pickup trucks generally include a truck bed adapted to carry or transport various types of cargo. It is important to properly secure cargo to the bed of the truck. Items that are allowed to shift in transit can become damaged, scuff the truck bed, or even become lost. Conventional load securing devices are adapted for use with large loads, and it is difficult to secure smaller items using such devices. Accordingly, there is a need in the prior art for a device that can secure smaller items in truck beds.

Devices have been disclosed in the prior art that relate to folding divider devices. These include devices that have been patented and published in patent application publications. These devices generally relate to using a movable apparatus, such as a gate, to create a section in a truck bed. Such devices include U.S. Pat. No. 8,100,615 to Freeborn, U.S. Pat. No. 6,827,533 to Cano-Rodriguez, U.S. Pat. No. 6,206,624 to Brandenburg, and U.S. Pat. No. 6,629,807 to Bernardo. These devices, however, fail to provide a folding divider device comprising a spring-loaded hinge that allows the device to open and fold for installation and uninstallation. Furthermore, these devices fail to provide inserts that allow for the adjustment of the device length and panels comprising one or more channels to receive one or more dividers therein.

One other device, U.S. Pat. No. 6,267,427 to Ziehl, provides a storage compartment that can fold flat in a truck bed. This device, however, fails to provide a folding divider device comprising a spring-loaded hinge that allows the device to open and fold. Furthermore, the device fails to provide inserts that allow for the adjustment of the device length and panels comprising one or more channels to receive one or more dividers therein.

In light of the devices disclosed in the prior art, it is submitted that the present invention substantially diverges in design elements from the prior art and consequently it is clear that there is a need in the art for an improvement to existing folding divider devices. In this regard the instant invention substantially fulfills these needs.

### SUMMARY OF THE INVENTION

In view of the foregoing disadvantages inherent in the known types of folding divider devices now present in the prior art, the present invention provides a new folding divider device wherein the same can be utilized for providing convenience for the user when separating and transporting items in his or her truck bed.

It is therefore an object of the present invention to provide a new and improved folding divider device that has all of the advantages of the prior art and none of the disadvantages.

It is another object of the present invention to provide a folding divider device comprising a first panel connected to a second panel, wherein one or more dividers are removably attached perpendicularly thereto so that one or more storage compartments are formed.

Another object of the present invention is to provide a folding divider device wherein the first panel and second panel are connected by a spring-biased hinge adapted to allow the panels to open and fold for installation and uninstallation.

Yet another object of the present invention is to provide a folding divider device including a panel having one or more vertical channels disposed thereon, wherein the channels are adapted to receive one or more dividers therein.

Yet another object of the present invention is to provide a folding divider device wherein the divider comprises a groove adapted to be disposed on the panel and a bumper disposed on the side of the divider to prevent the divider from damaging the tailgate of the truck bed.

Another object of the present invention is to provide a folding divider device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the folding divider device.

FIG. 2 shows a rear perspective view of an embodiment of the folding divider device.

FIG. 3 shows a perspective view of a divider.

FIG. 4 shows a perspective view of an end piece connecting to an insert and the insert connecting to a panel.

FIG. 5 shows a perspective view of an embodiment of the folding divider device in use.

FIG. 6 shows a perspective view of an alternative embodiment of the folding divider device in use.

### DETAILED DESCRIPTION OF THE INVENTION

Reference is made herein to the attached drawings. Like reference numerals are used throughout the drawings to depict like or similar elements of the folding divider device. For the purposes of presenting a brief and clear description of the present invention, the preferred embodiment will be discussed as used for separating and transporting items in a truck bed. The figures are intended for representative purposes only and should not be considered to be limiting in any respect.

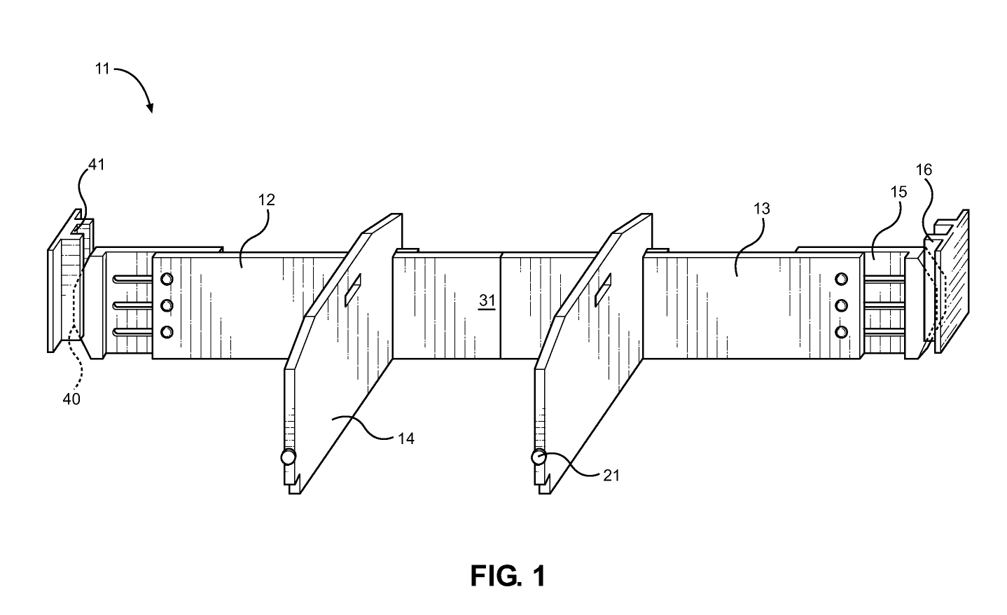

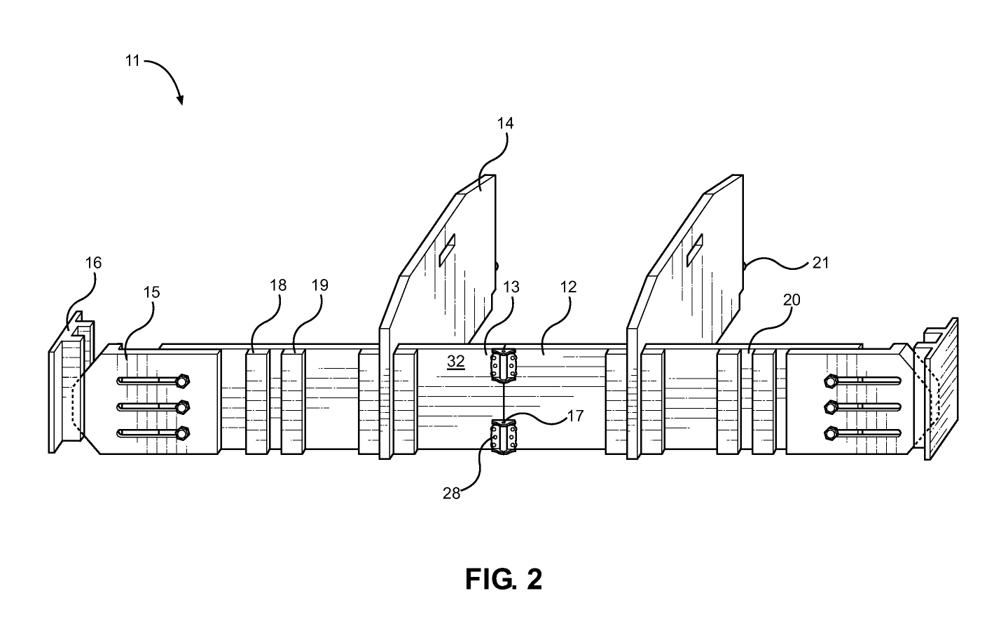

Referring now to FIGS. 1 and 2, there is shown a perspective view and a rear perspective view of an embodiment of the folding divider device. The folding divider device 11 comprises a first panel 12 and second panel 13, wherein the first panel 12 and second panel 13 have a first end opposite a second end. The second end of the first panel 12 is permanently and pivotally affixed to the second end of the second panel 13 by a spring-biased hinge 17. The panels 12, 13 are preferably substantially similar in structure and dimension. The panels 12, 13 include one or more vertical channels 20 thereon, which are adapted to receive one or more dividers 14 therein. The folding divider device 11 further includes a first and second insert 15, each having a first end 40 opposite a second end, wherein the inserts are adapted to allow a user to adjust the length of the device 11 to fit within a truck bed. A first insert 15 is adjustably connected to the first panel 12 and a second insert 15 is adjustably connected to the second panel 13. The device 11 further includes a first and second end piece 16 each having an inner surface and an outer surface, wherein the outer surface is adapted to attach to one or more sides of a truck bed. The inner surface of the end pieces 16 include an elongated slot 41 adapted to receive the first end 40 of an insert 15 therein. In this way, the end pieces 16 attach the device 11 to a truck bed. The first and second inserts 15 are substantially similar in structure and dimension. The first and second end pieces 16 are preferably identical in structure.

The spring-biased hinge 17 is adapted to allow the user to open or fold the panels 12, 13. Once the user has installed or uninstalled the device 11, the hinge 17 allows the panels 12, 13 to maintain an opened or closed position thereafter. The hinge 17 is secured to the panels 12, 13 by any suitable fastener, such as screws 28. In other embodiments, there can be one or more panels permanently attached allowing a user to store an uninstalled device in shorter sections or one long section.

The panels 12, 13 are elongated, rectangular in configuration, and have an inner 31 surface and an outer surface 32. The inner surface 31 is substantially flat. When the device 11 is uninstalled and in the closed position, the inner surface 31 of the first panel 12 rests flush against the inner surface 31 of the second panel 13. The outer surface 32 includes one or more pairs of vertical supports 18, 19 that extend outwardly thereon. The pair of supports 18, 19 rest flush against the outer surface 32 of the panel 12. The supports 18, 19 are preferably rectangular, substantially identical in configuration, and parallel to each other. The height of the support 18 is preferably substantially similar to the height of the panel 12 so that when the device 11 is folded, the support 18 will not extend beyond the panel 12. The vertical supports 18, 19 may be placed at a variety of positions along the length of the panel 12. In some embodiments, the supports 18, 19 may include one or more pairs of pegs separated by a space adapted to receive a divider 14.

A channel 20 is formed between a pair of supports 18, 19 and is adapted to receive a divider 14 therein. The channel 20 is preferably substantially the same width as the width of the divider 14 so the divider 14 can fit therein and be secured in place. The supports 18, 19 can be permanently secured to the panel 12 by any suitable fastener, such as screws, nails, or adhesives, among others. The panels 12, 13 and supports 18, 19 can be composed of any suitable material, such as plastic, wood, or metal.

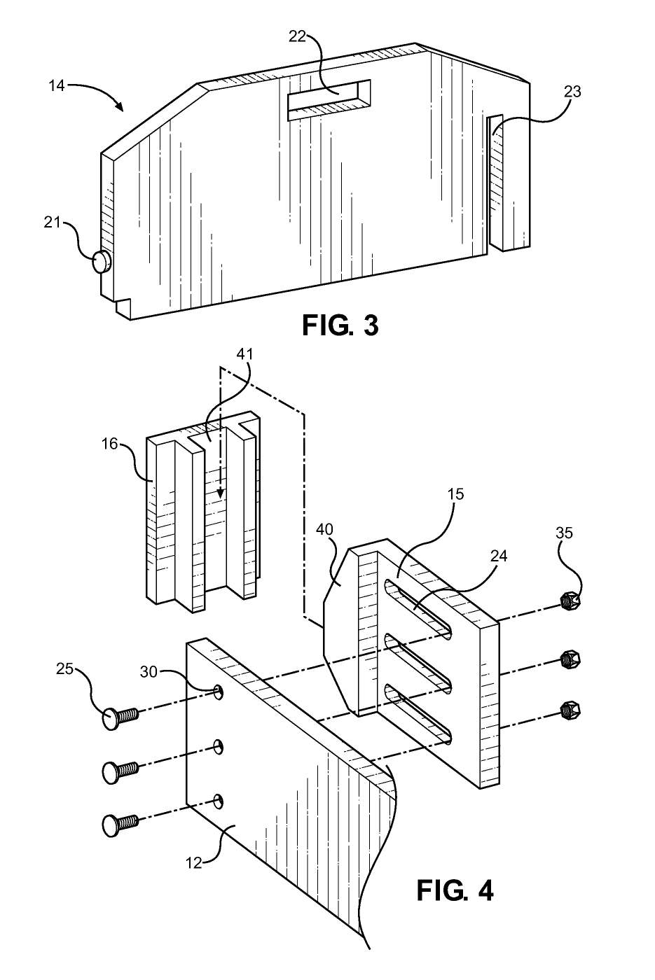

Referring now to FIG. 3, there is shown a perspective view of a divider. The divider 14 is substantially rectangular in configuration and comprises an upper end opposite a bottom end and a first side opposite a second side. The bottom end of the divider is substantially flat so that it can rest flush against the bed of a truck. Furthermore, a groove 23 extends upward from the bottom end of the divider 14 towards the upper end thereof. Preferably, the groove 23 is positioned near the first end of the divider 14. The groove 23 can be positioned over a portion of a panel so that the divider is oriented vertically and such that the divider 14 is perpendicular to the panel. The upper end comprises an elongated aperture adapted to form a handle 22. The handle 22 can be used to move the divider 14 and assist the user in placing the divider 14 over the panel 12. The second side of the divider 14 comprises one or more bumpers 21 preferably composed of an energy absorbing material, such as rubber or plastic. The bumper 21 is adapted to prevent damage to the tailgate by absorbing the impact that may result from the tailgate coming into contact with the second side of the divider 14. The divider 14 can be composed of any suitable material, such as wood, plastic or metal.

Referring now to FIG. 4, there is shown a perspective view of an end piece connecting to an insert and the insert connecting to a panel. The insert 15 comprises a first end 40 opposite a second end. The first end of the panels 12, 13 include one or more apertures 30 adapted to be removably secured to the second end of each insert 15. The insert 15 further includes one or more horizontal slits 24 adapted to align with the apertures 30 of the panels 12, 13. The slits 24 and apertures 30 are preferably spaced vertically at fixed intervals. The diameter of the aperture 30 is preferably substantially similar to the width of the slit 24 so when they are aligned, a fastener can fit therein. The length of the slit 24 can extend much of the length of the insert 15, thereby providing the user with the capacity to adjust the length of the divider device 11. The slits 24 can align with the apertures 30 as each panel 12, 13 overlaps the second end of each insert 15 at the desired position. Once overlapped, the inserts 15 and panels 12, 13 are removably attached by any suitable fastener, such as a bolt 25 and nut 35. In some embodiments, the inserts 15 can be permanently attached to the panels 12, 13.

The end pieces 16 can be disposed on the sides of the truck bed so to prevent the device from shifting while in use. The outer surface can be flat in order to rest flush against another substantially flat surface. Therefore, the device can be adapted to fit within an area of a vehicle that does not include grooves thereon, such as the front portion of a truck bed. Preferably, the outer surface of the end pieces 16 include a fastener thereon, such as an adhesive, to further prevent the device from shifting while in use. The inner surface includes an elongated slot 41 adapted to receive the first end 40 of an insert 15 therein. The width of the elongated slot 41 is substantially identical to the width of the first end 40 of the insert 15 so that the insert 15 fits removably securely therein. In some embodiments, there can be one or more inserts 15 adapted to be disposed between one or more panels 12 or one or more end pieces 16 so that the folding divider device 11 can be attached to the truck bed at a variety of positions within the truck bed.

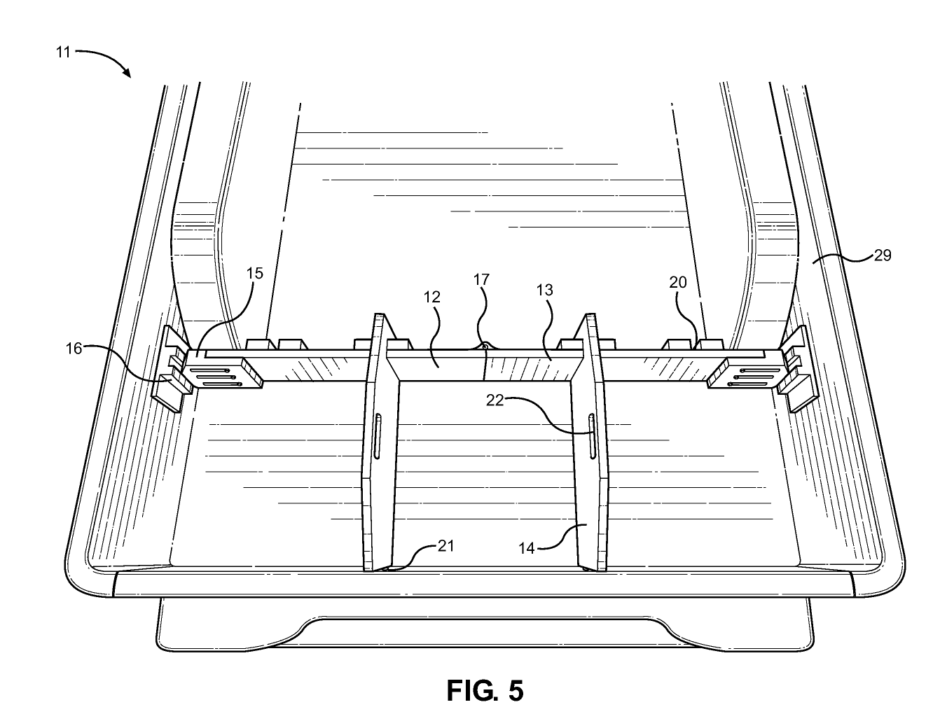

Referring now to FIG. 5, there is shown a perspective view of an embodiment of the folding divider device in use. In operation, the user opens the first and second panel 12, 13 to a 180 degree angle, wherein the spring-biased hinge 17 exerts enough force to maintain the panels 12, 13 in an open position. Next the user overlaps the panels 12, 13 with the inserts 15, thereby aligning the apertures with the slits. In this way, the user can choose the length of the device 11 so that it fits within his or her truck bed 29. A removable fastener is disposed first through the aperture and then through the slit. The first end of the insert 15 is then placed within the elongated slot of the inner surface of the end piece 16. The end piece 16 is fastened to the truck bed 29 by disposing the substantially flat outer surface of the end piece flush against the substantially flat surface of the truck bed 29.

Once the panels 12, 13, inserts 15, and end pieces 16 are in place, the user disposes one or more dividers 14 on the panels 12, 13. Using the handles 22, the user lifts the divider 14 and places the groove of the divider 14 on a panel 12, 13 between the pair of supports and within the channel 20. The user can close the tailgate, wherein the bumper 21 is engaged therewith and protects the tailgate from damage. The divider 14 is disposed on the panel 12, wherein a plurality of compartments are formed in the truck bed 29. In this way, the user may separate and transport items in his or her truck bed 29. In some embodiments, the folding divider device 11 may be placed in the rear, center, or front portion of the truck bed 29.

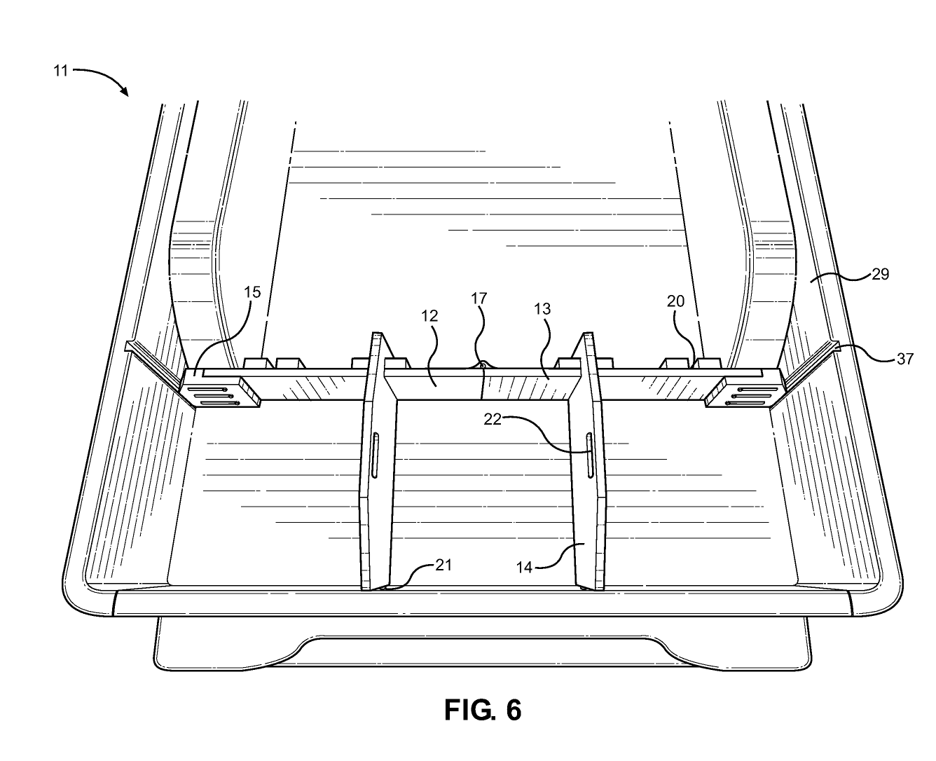

Referring now to FIG. 6, there is shown a perspective view of an alternative embodiment of the folding divider device in use. In this embodiment, the end pieces are not required. The device 11 can be removably attached to the truck bed 29 by placing the first ends of the inserts 15 directly into one or more grooves 37 on the sides of the truck bed 29.

The user can uninstall the device 11 by removing the dividers 14 and detaching the inserts 15 from either the end pieces or, in the alternative embodiment, the grooves 37. Next the user can unfasten the inserts 15 from the panels 12, 13. The user can fold the first panel 12 and second panel 13 together, wherein the inner surface of the panels 12, 13 is flush.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A folding divider device for a flat bed, comprising:
a first panel and a second panel, wherein said first and said second panel each have a first end opposite a second end, an inner surface, and an outer surface;
one or more dividers removably attached to said first and said second panel;
a hinge connecting said first panel to said second panel, wherein said hinge is adapted to fold and open said first and second panel.
a first insert and a second insert each having a first end opposite a second end, wherein said first insert and said second insert are adapted to engage said first panel and said second panel, respectively;
a first end piece and a second end piece each having an inner surface and an outer surface, wherein said first end piece is adapted to engage said first insert and one or more sides of a truck bed and said second end piece is adapted to engage said second insert and said one or more sides of a truck bed.

2) The folding divider device of claim 1, wherein said first panel and said second panel each comprise one or more pairs of vertical supports adapted to receive said one or more dividers therein.

3) The folding divider device of claim 2, wherein said one or more pairs of vertical supports are fastened to an outer surface of said first panel and said second panel.

4) The folding divider device of claim 1, wherein said one or more dividers comprise a groove adapted to be disposed on said first panel and said second panel such that said one or more dividers are perpendicular thereto.

5) The folding divider device of claim 1, further comprising one or more bumpers disposed on a second side of said one or more dividers.

6) The folding divider device of claim 1, wherein said one or more dividers comprise a handle.

7) The folding divider device of claim 1, further comprising one or more apertures arranged along said first end of said first panel and along said first end of said second panel, such that said one or more apertures are aligned vertically on said first and second panel.

8) The folding divider device of claim 7, wherein said first insert and said second insert comprise one or more horizontal slits that extend from said first end to said second end.

9) The folding divider device of claim 8, wherein said first insert and said second insert are removably attached to said first panel and said second panel, respectively, by means of aligning said one or more slits of said first insert and said one or more slits of said second insert to said one or more apertures of said first panel and said one or more apertures of said second panel, respectively, and fastening thereto.

10) The folding divider device of claim 1, wherein said inner surface of said first end piece and said second end piece includes an elongated slot adapted to receive said first end of said first insert and said first end of said second insert therein.

11) The folding divider device of claim 1, wherein said outer surface of said first end piece and said second end piece includes a fastener adapted to permanently attach said first end piece and said second end piece to said one or more sides of a truck bed.

12) A folding divider device for a flat bed, comprising:
a first panel and a second panel, wherein said first and said second panel each have a first end opposite a second end, an inner surface, and an outer surface;
one or more dividers removably attached to said first and said second panel;
a hinge connecting said first panel to said second panel, wherein said hinge is adapted to fold and open said first and second panel.
a first insert and a second insert each having a first end opposite a second end, wherein said first insert is adapted to engage said first panel and one or more sides of a truck bed and said second insert is adapted to engage said second panel and said one or more sides of a truck bed.

13) The folding divider device of claim 12, wherein said first panel and said second panel each comprise one or more pairs of vertical supports adapted to receive said one or more dividers therein.

14) The folding divider device of claim 13, wherein said one or more pairs of vertical supports are fastened to an outer surface of said first panel and said second panel.

15) The folding divider device of claim 12, wherein said one or more dividers comprise a groove adapted to be disposed on said first panel and said second panel such that said one or more dividers are perpendicular thereto.

16) The folding divider device of claim 12, further comprising one or more bumpers disposed on a second side of said one or more dividers.

17) The folding divider device of claim 12, wherein said one or more dividers comprise a handle.

18) The folding divider device of claim 12, further comprising one or more apertures arranged along said first end of said first panel and along said second end of said second panel, such that said one or more apertures are aligned vertically on said first and second panel.

19) The folding divider device of claim 18, wherein said first insert and said second insert comprise one or more horizontal slits that extend from said first end to said second end.

20) The folding divider device of claim 19, wherein said first insert and said second insert are removably attached to said first panel and said second panel, respectively, by means of aligning said one or more slits of said first insert and said one or more slits of said second insert to said one or more apertures of said first panel and said one or more apertures of said second panel, respectively, and fastening thereto.
